(19) United States
(12) Patent Application Publication
(10) Pub. No.: US 2007/0208628 A1
(43) Pub. Date: Sep. 6, 2007

(54) System and method for content and time merchandizing

(76) Inventor: Ahmad Amiri, Richmond Hill (CA)

Correspondence Address: AHMAD AMIRI, 21 DUNLOP ST. # 207, RICHMOND HILL, ON, L4C 2M6, CA

(21) Appl. No.: 11/365,837

(22) Filed: Mar. 2, 2006

(51) Int. Cl. G06Q 30/00

(52) U.S. Cl. 705/26

(57) ABSTRACT

An on-line exchange, called TimeEx, to or on which Stars, typically Celebrities link or host their Websites, which Websites show their lives, houses, movements in recorded and or real time, or offer live interactive interviews to many or just one. Fans can log onto TimeEx, search for their favorite Star, pay the price to watch Stars Website, or even bid in an auction to have a one to many or one to one interview with the Star. The concept can be expanded in many ways, such as use by non celebrities, creation of an Exchange where Time Defined Merchandize such Ad Slots, personal time, airtime, etc. are bought and sold. Revenues can be earned by the Operator of TimeEx by charging Fans, Stars, Advertisers, Intermediaries, Providers, etc, and by Stars charging Fans, Advertisers, and even the Operators or others for bringing eyeballs to their Sites.

### BACKGROUND

This Invention is a System and Method, linking demanded suppliers of content with those who demand it. There is a very large supply of various types of “content”, and various degrees of demand to access such content. This Invention is to create an Exchange and or Market for content, via the Internet or other media. The Invention is especially suited to cater to curiosity about celebrities.

### BRIEF SUMMARY

Celebrities, referred to here as Star or Stars, are of great interest to the public, referred to here as Fan or Fans, who like to know what Stars do, where they go, how they live, how they conduct their affairs, how they look outside TV or movies, and even to talk to them. But as yet no systematic way of catering to this exists.

Currently, stars are followed by paparazzi, to produce photos, videos and stories about them, to be sold to tabloids and gossip columns. Biographies, authorized or not, deliver polished or tarnished stories of Stars past. Occasional press, TV or Radio interviews are another outlet. Other current methods of serving curiosity about Stars need no detailing here as well known to the skilled and even unskilled. Each of prior art approaches has some or many of following or other known or felt disadvantages, such as, usually not live, interfering with stars, breach of privacy, often without stars' consent, selected clips only is released to public, public has little choice as to what to see or hear or know, stars have little choice as to what the Fans are fed as information, little or no direct interaction between Stars and Fans, false or unreliable information about Stars given to public, Stars often make no direct money from what is published about them, Stars have no proprietary rights over contents produced about them,

This Invention, briefly is a Website, called here TimeEx (short for Time Exchange), to which stars own Websites or pages are “linked”, to be accessed by Fans, perhaps by paying. Stars can post recorded or live, even interactive interviews, recorded or live video, voice, text etc., to their Websites, for Fans' access.

One feature uses Web cams installed in a Star's office, car, home, bedroom(s), or carried by entourage, which can be controlled by the Star for times they can be on, angles of view, what is uploaded for public view, etc. Said Web cams upload to the respective Star's Website, inn real time or delayed.

Fans then can log on to TimeEx, choose their desired celebrity from lists and directories on TimeEx, pay any charges applicable for browsing their desired Web Pages, for example a live Web cast of an actor having dinner at home.

By paying the right fee, a Fan may participate in a Web cast public interview with a celebrity, get to ask questions, perhaps by paying more, or even have a one to one chat with the Star, perhaps by paying even more.

There can be various fee structures and non-fee prioritizing of who has access to TimeEx content, such as lottery or incentive coupons, etc. Fees can be distributed to TimeEx operators, communication operators, Stars, charities, governments, etc. Thus, not only all of the problems of prior art listed above are resolved to various degrees, but many other advantages are created.

The System and Method can be extended to all kinds of “content”.

### DESCRIPTION

An Entity, usually but not necessarily a business, here called “Operator” creates a Website, called here a Portal. Fans who access Said Portal can access to Websites, created by Stars, here referred to as “Starsites”, via “Links” in said Portal. Stars aiming to serve their Fans curiosity, tell their side of the story v tabloids, make money from Fans or Advertisers, for themselves and or charities, own their personal stories, deliver their messages and views, extend their public portrayal, or achieve any other objective(s), can subscribe to be listed on said Portal Links.

Stars can have Web Enabled Cameras referred to here as Web cams, installed in their place of work (say office, cabin, trailer, stage, set, studio, dressing room, etc), place of living (say house, cottage, hotel room, etc.), on the move (say car, boat, plane, train) or even as walking (using a cell-phone or other camera carried by the Star, or staff) can create pictures or videos for live or delayed Web cast.

There can be many Web cams installed in many locations, even in bedroom(s). Web cams can be controlled, preferably remotely, ideally over long distances. Controlling enables the Star to chose which Web cam to be on, view angles, times to be off, etc. Each Web cam has its own Web address (or sub-address), allowing viewers can choose which to watch.

To save any embarrassments, Live Web casts can have Editing features such as an editor checking each batch before uploading to Starsite, or upload with a delay of say seconds or minutes or more, to allow any needed editing or intervention. Stars or their staff, said Operator or even Service Provider(s), can perform such Control and Editing based on pre-agreed control and editing criteria.

For example, one “Control” criteria may be that the bedroom Web cam to be on only at daytime. One typical “Editing” criteria can be to delete, blur or mask any images that show a naked person. Many limitations and variations are possible. For example, sound and/or pictures but not videos only to be uploaded. Stars can upload written, verbal, graphic or video material such as articles, photos, statements, clips, timetable of events, promotions, etc. to their Starsites.

We will refer to such Service Provider(s), who provide editing and or other Services to Stars, Fans and even to the Operator, in this Specification, as “Provider(s)”.

Web cams are referred to here to include any media, such as microphone for sound, camera for pictures, video recorder for video, computer for text, or any other device that can record and or transmit content from a location to Starsite.

Other “transmittable”, “electronic” or “photonic”, digital or analog signals can also be recorded, uploaded and received, using suitable existing or future devices. For example “scent” digitizers and receivers already exist. So a Star's perfume can also be uploaded.

More importantly, devices to digitize and transmit texture, heat, vibration and or other skin felt sensations are being developed, together with suitable receivers, which can recreate digitized and transmitted senses for remote sensing. Fans may be able to feel a Star's skin, clothes texture, body heat and vibes.

The words digital or digitized here refer to any signals transmittable over long distances, as technologies to transmit light, or perhaps other signals, with or without digitizing are being developed.

Interaction with Stars is also possible. Time and dates of such events can be published on the Star's Starsite and/or TimeEx Portal, under a special category for time sensitive content (as distinct from content that can be viewed any time). Stars may offer public Web cast interviews. Many Fans will only watch and or listen and or read about their favorite Stars, but some who are willing to pay more or are chosen by some other selection Formula, may make questions, statements, suggestions, etc perhaps anticipating the Star's response. Such events can be conducted and moderated by the Star's Staff or as a service provided by the Operator or by a Provider.

One step further will be to have one to one sessions with the Star. This may require paying more fees or being selected by some criteria or Formula. Even dancing with the Star is possible. A Star and a Fan, each looking at their own screen, (which may be stationary or portable, head worn, goggle or eye worn), watching the other in real time, listening to the same music can dance. Internet live communication usually has some streaming delays, but more bandwidth and newer technologies can rectify or reduce this problem.

One major convenience that this Invention can provide is that Stars need not develop their own Websites or Web cast systems. All a Star needs to do is to install Web cams wherever they choose, and subscribe to the Operator, and from then on it is plug and play. Operator and or Provider(s) can offer assistance, provide, sell or lease Web cams, templates, manuals, software plug-ins, scripts, constancy and or any other needed tools and services.

Another advantage is that a Star may, but need not, market his or her Website. TimeEx marketing and general public knowledge of TimeEx will often suffice. Fans log on to TimeEx and from there choose their favorite Stars' links.

Operator can generate revenue by advertising on the Portal or even Starsites, from subscription fees charged to Stars and/or Fans, and providing various services, some of which are mentioned in this description.

Stars can generate revenue by charging Fans to visit their Starsite or to participate as audience in Star's presentations, ask questions, have private interviews or other services of interest to Fans, and or by selling advertising time and space on their Starsites or even on TimeEx pages where the search for a particular Star makes such page interesting to attract eyeballs.

Another feature is Pricing the services. Artificial or real agents can be used to increase total revenue. For example, a Starsite receiving low volume of hits can reduce its peeping fees, even offer it free to increase advertising revenue. usually, but not necessarily, Pricing applies to passive viewing of Starsite without Star's limited time being used, and more Fans means just adding more band width and perhaps more customer (Fan) service capacity, but does not need Star's attention.

Pricing can be Dynamic, say determination of Price based on supply and demand, or Static, both of which may be done in Advance, in Real Time, or even After delivery or use of a service, say before, during or after viewing a Starsite. Delayed or future based pricing is sometimes a good option, enabling parties to determine price based on some future based Formula such as an index.

A more important feature is using any and all of auctioning systems to reduce number of users of a special service to manageable numbers. For example, a Star presentation can only take so many participants who are allowed to ask questions. Those active participants may be selected from a prior or real time auction.

As mentioned, there are many auction systems suitable for various circumstances. Other, even non-monetary selection methods can also be used. Selection and Auctions can be done by Intelligent Software or Agents or Bots or by Staff.

Services such as Selection by Auctioning, Pricing or other Formula may be performed by software or personnel or both, administered by Stars and or Operator and or Provider(s) and or permutations thereof. However, a preferred version would have an Operator handling only the TimeEx as an Exchange, leaving transactions between Stars and Fans to themselves, perhaps providing them with software or systems to do so, or enabling the system to allow Provider(s) to help.

Pricing, Auctioning or other Formula can be used to Allocate Content, Advertising and Stars Time. For example the content to view, say swimming pool Web cast of a Star can be priced, as by providing enough band width, which is easy, there is no reason to limit the number of people watching it. So “pricing” may be the best option, to optimize the total revenue from viewers and advertisers. However advertising on a Starsite considering many factors such as time, duration, screen location, type, such as pop-up, video clip, voice, or others are perhaps, better allocated by some Formula, which considers all above. When it comes to allocating a Stars Time, for shared or one to one interviews, Auction may suit best. The actual choice of methodology for allocation of abundant or limited resources is best left to parties concerned. But the System and Method of this Invention can accommodate many ways of achieving desired results.

The Invention can accommodate Intermediaries, for example those who line up a number of Stars, say in their region, and connect them to TimeEx directly or via Intermediary Site(s). Various Fee structures can be implemented, between Stars, Operator, Intermediaries, Provider(s), Fans and even Communication Companies (Cable, Wireless, Fiber Optic, Satellite, ISPs, and or others).

Many TimeEx Sites or Sub-Sites can be created which specialize in some categories of Stars or other contents. Say Portals or Sub-Portals specializing in Musicians, Writers, Politicians, etc.

### EXPANDING THE SCOPE OF THE INVENTION

Every aspect of the Invention can be expanded to a much broader scope. Star can be generalized to be Offeror, Vendor etc, Fan can be generalized as Offeree, User, etc, and Content can be anything Deliverable on line, as explained here.

Some Categories of Content that can be offered by Stars via the TimeEx are Recorded, Live, Shared Interactive and Exclusive Interactive, as elaborated below.

“Recorded Content”, can be photos, videos, voices, sounds, tunes, aromas, articles, statements, on-line books etc. This category does not require Star's real time or participation or attention, although may take Star's time off-line.

“Live Content”, can be videos, sounds, voices, even scents captured by Web cams, Microphones or other devices, installed around a Stars home, entourage, office, etc for live upload to Starsites to be offered to Fans via TimeEx. In this category, even though a Star may be shown live via a Web cam, but there is no need for Star's personal, real time attention, as he or she may be going on with life while being watched by Fans.

Any “Live Content” which is transmittable electronically, electromagnetically, phonically, or by any other instant and remote means of transmission, can be offered via TimeEx. These can be lectures, concerts, interviews, mass hypnosis, political speech, events, parties, demonstrations, satellite views, telescope views, matches, etc.

Star of a “Recorded Content” or “Live Content” is not necessarily a Celebrity, but can be an “entity”, often “not a real person”, such as NASA offering a moon landing, National Geographic offering birth of an elephant, NHL offering a hockey match or CNN showing news.

“Shared Interactive Content”, may also be Offered via TimeEx. Example is as an interview with the Star, where some selected persons or Fans can ask questions or give comments, even thought it may be viewed, non-interactively by other Fans.

While Recorded or Live Content can be offered to almost unlimited numbers, “Shared Interactive”, can be utilized by only a limited number of Interactive Fans. “Star's Time” must be allocated via the TimeEx, to a finite number of users.

A Star can be expanded to include Teachers, Tutors, Politicians, or other who offer Live Presentations in which some Fans which can be expanded to include Students, Pupils, Listeners, Viewers or other Users are selected by paying a Fee, or by Auction or by other Farmula (s), to interact with the Star.

A Star does not have to be a real person, but a Proprietor of a demanded service. One typical case is a Web cam, installed on a tower, helicopter, plane, satellite or the like, where some selected Fans, in this case Viewers, can manipulate the angle and zoom of the Web cam for a time. There can be other potential viewers who have not paid as much or are not selected, who can only view.

“Exclusive Interactive Content”, or One to One Interaction with a Star, is another form of Content that may be Offered via TimeEx. Star can be a movie star, but may be expanded to include Doctors, Psychologists, Consultants, Teachers, Fortune Tellers or any other Offeror, where the Fan or User or Offeree requires the Exclusive and perhaps Confidential attention of the Star or Offeror. Just as we explored the possibility of dancing with a Star on line, a dance teacher can teach one to one on line. This type of Content requires Star's Real-Time participation.

Put differently, a finite number of limited chunks of “time” are allocated to a finite number of users to use one at a time. Therefore selection by pricing, auction, non-monetary criteria or otherwise would be necessary to reduce the number of Interactive Fans to one for any available batch of time.

“Advertising” is another category of Content, which may be Offered on TimeEx and or Starsites and or Providers Sites and or Intermediaries Sites. Advertising usually does not require a Star's Real-Time participation, but it does require Dedication of Area and Location(s) on the Screen, Duration, Staring Time (including date), collectively referred to as “Ad Slot”. Thus some Selection mechanism, such as Price, Auction, Points system is called for allocation.

Expansion Beyond Celebrities

Stars used in this application are usually, but not necessarily publicly known persons and or entities. To explain the full scope of this System and Method, we create two broad categories of Stars, referred to in this Specification as “Celebrities” and “Professionals”.

Celebrities are typically movie stars, musicians, writers, politicians, pop singers, religious leaders, famous scientists, or other well known persons.

They can also include well-known practitioners such as doctors, psychologists, hair stylists, fortune tellers, teachers, instructors, comedians, priests or others. Also legal entities such as NASA, National Geographic, CNN, governments, etc. Even unincorporated entities such as a TV show, which is not separately incorporated, but well known and identified by the public. Dead persons and or their Estates can qualify, as would Einstein.

The other category of Stars are called “Professionals” here, merely as a name, and for lack of a better word to encompass all that qualify in the sense used here. They can be doctors, psychologists, teachers, instructors, companions and generally offerors and or vendors of any Content and or Service that can be offered on-line. The word “Offeror” is more inclusive, but it has been used to include both groups.

One distinction is that Celebrities are well known in some geographical, political, social or other space, and usually sought and followed with interest by large numbers of people, while Professionals are not.

A famous psychologist and a little known one offer the same psychiatric advice on line, but first is a Celebrity and the latter is Professional in this Specification. From a practical and or commercial point of view, people seek Celebrities while Professionals seek people as customers. While Fans would typically seek Celebrities by name in TimeEx link directory, when looking for an on-line psychologist, they will more likely look for the “Psychiatrists” first, then narrow down to few and the one they will use.

Commercial and other implications are important enough to make the distinction. Some prior art that applied only to Celebrities can be expanded in “use” to Professionals and vice versa.

TimeEx can be used by Professionals too. Therefore almost anyone who wishes to offer or present content, some categories of which are elaborated above, can use TimeEx. Some examples follow.

A piano instructor, who is not yet famous, can teach piano on line, by offering text, voice, sound or video instructions, as Recorded Content, and or Web casting her classroom as Live Content and or coaching some selected pupils as Shared Interactive Content and or coach one person as Exclusive Interactive Content, and or use other ways of doing so. Note that a digital piano and real time streaming of video and sound are all technically available and are being advanced.

TimeEx provides such a piano instructor with a Marketing forum, Links to be traced, Pricing tools for Recorded or Live Content for which there is no limit as to the number of students who can download or view, Auctioning tools to narrow down the Interactive participants to a manageable number or to one, other Services and or Providers to help her in every aspect, Intermediaries who serve her more specific needs, such as those who cater to music industry, and so on.

Extensions of Use

Some of what is explained in this specification can be reclassified as New Use. There are instances where a method is partially applied to some circumstances, but not as broadly as suggested here.

Extending Use of TimeEx from Celebrities to Professionals was explained. Another is extension of certain Use of Internet by Professionals to Celebrities. Example, offering “time” over the Internet, by some professionals. Extension to Celebrities to use a similar method has dramatic commercial, social, political and other effects. Another extension is to Contents not previously offered on line.

Advertizing Market and or Exchange

An interesting result is obtained by offering “Shared Ad Slot” instead of “Shared Interactive Content” (explained elsewhere in this Specification), where the term “Star” refers to a Proprietor of a popular Website or Broadcast media, to be called “Ad Site” here, and where Fans are “Ad Site Users”, Persons or Entities who wish to Advertise, Speak, Write, Perform, Express . . . on such Ad Site(s).

Ad Sites can be or become popular. In addition to already popular Ad Sites, such as NASA Website, it is expected that, TimeEx Portal, Providers Sites, Intermediaries Sites and many Starsites, especially those of Celebrities and some of Professionals will be or become useful as Ad Sites.

Just as TimeEx can allocate limited time on a Starsite for Interactive Content, it can by analogy be used by any Ad Site Proprietor to Offer Advertising Slots, specified by Time, Duration, Location(s) and Area on the Screen, “Event”, Mode or other measures, to a number of Ad Site Users. In this case, Ad Site can typically be used by more than one User. A Website can have many advertisers on the same page.

If an Ad Site can be used by just one User at any period of time, as with Radio, and usually for TV, above analogy will replace “Exclusive Ad Slot” for “Exclusive Interactive Content”. Allocation of Ad Slots to applicants can be by Pricing, Auction or other Criteria such as First Come First Served.

An Ad Site is either the same as a Starsite or part of it, say one or more pages or part of a page or just linked to a Starsite, to be viewed at Users option.

Thus an Advertising Exchange and or Market is created, to be called “AdEx” here. Perhaps the first and more regular offerors of AdEx will be Stars who wish to sell Advertising Slots on their Starsites. TimeEx can do the work of AdEx and there is no need for a different Portal. However, one can create an exclusive AdEx Portal.

TimeEx and or AdEx can also market Banners or Billboard Space, which quality and price depends usually on “location”, which is non-perishable, i.e. a bus stop, but generally not on any “event”, while Ad Slot prices depend on as “event” such as being shown during a Star live interview, and hence are “perishable”, which calls for more efficient, speedy, real time sales and delivery. TimeEx and or AdEx make all said steps seamless and efficient, so that Ad Slots are used up before expiry.

An Ad Site can be created not just by having popular content, but by incentives. For example, a Broadcaster can pay a number of Venture Capitalists to view it. Entrepreneurs looking for capital then pay Broadcaster to present their projects.

An Ad Site may be off Internet or off Web, say as a Radio or TV Station or Channel, Magazine, Newspaper or other attractor of eyes or ears. In such case, AdEx or TimeEx can be used for selling Ad Slots on such off Internet Ad Sites. Ad Slots sold or allocated via AdEx are then consumed on a different media.

Use of Timeex for Air Channel Allocation

TimeEx or AdEx, being a market and or exchange for “scarce” Ad Slots, can be used to “allocate” scarce Radio, Cable, Satellite and TV channels to best use. Auctioning “channels” to highest bidders, Pricing them, manually or by intelligent software, to attract only as many users as there are channels, or adopting a non-monetary criteria or point system of Grading the most eligible users, etc, all can be done via TimeEx.

Also, which programs to air on each channel can be decided using TimeEx. Programs that fetch highest advertising revenue or highest viewing revenue or highest points as graded buy users, occupy those channels. Briefs of programs being Offered and system of Selecting the winners (Auction, Price or Grading, . . . ) can be demonstrated via TimeEx.

No longer a hit and miss broadcasting management guess, top to bottom or vendor to seller decision, but a point system from final users to the broadcasters. Thus those scarce airtimes can be efficiently allocated, to best use.

One scenario is that a “Content Broker” (CB), (applicant believes this phrase is used for the first time here, in addition to novel concept), provides a brief of various Contents (say documentaries, movies, paparazzi footage, . . . ), on CB Website linked to TimeEx as a subscriber. CB puts said Contents through a Voting process and chooses the ones fetching highest votes to fill one TV channel. Thereafter CB Auctions the Ad Slots that can accompany said Content, perhaps using the number of votes as a rating proxy. CB then purchases TV airtime from a Satellite operator, who is using a Pricing system to sell its available airtime, enabling CB to know in advance what price he will have to pay for each channel. CB then informs, all winners of Content he had auctioned to watch said channel, by email or via CB Website or otherwise, of the channel number and time their favorite footage is being aired. Time of airing should be within bounds CB had offered as the Content were being auctioned.

All steps including but not limited to Voting to choose the most popular contents, Auctioning Ad Slots and Purchasing airtime can be done via the same TimeEx.

Another scenario is that a Singer uses TimeEx and Pricing model, to sell a Radio Concert to enough listeners to participate in an Airtime auction, to perform it, perhaps without commercials. All steps can be performed via TimeEx.

Category Timeex or Sub Timeex

It is a good idea to have specialized TimeEx exchanges for various categories. TimeEx(es) that suits celebrities may not be the best forum(s) for professionals. Some TimeEx(es) can serve locals for what is irrelevant to distant users.

Categories can be created by many criteria, such as Fan based, by age, sex, hobbies, . . . Star based such as actors, politicians, . . . , Geographically based such as by country, city, . . . , or Subject based such as science, theater, . . . and so on.

Selection Systems Reviewed

This Specification uses Auctioning, Pricing and Grading as some “Selection” tools. There are many known variations of each, and no need to explore them here. Users of TimeEx, be it Stars, Fans, Providers, Intermediaries or others in the broadest sense of the word “User” will decide the best system of Selection for various circumstances. However, a brief review seems in order.

Auctioning, typically lets buyers bid up the price so that only the highest bidder(s) get the one or limited number of available merchandize for sale.

Pricing typically means setting the Price, by analysis, trial and error, instinctively or otherwise such that there will be almost as many buyers as there are goods. Either enough goods are sold to satisfy the vendor or enough buyers get goods not to be disappointed or all goods are sold but not much beyond availability.

Pricing can be Dynamic, say determined by supply and demand as figures evolve, or Static, based on guessed or predicted measures. Both of which may be done in Advance, in Real Time, or even After delivery or use of a service, say before, during or after viewing a Starsite.

Delayed or future based pricing is sometimes a good option, enabling parties to determine price based on some future based Formula such as an index.

Selection by Criteria or Formulae or Grading can be used to select Fans or Users or Offerees who are allowed to take advantage of an Offer. For example, an author may wish to allow certain age groups to view her Starsite.

Grading uses usually non-monetary Criteria such as a Points system to quantify, and then use such quantification instead of pricing or bidding to allocated limited quantity of availabilities to applicants. Voting is one of those systems.

All can be done by intelligent software, on-line and or via TimeEx or off-line. All can be done Post delivery (based on some pre agreed or published criteria such as future value of an Index) and or Prior to delivery and or in Real Time.

Delivery here means making the Content, Ad Slot or whatever is being bought or sought, available by Offeror for use to Offeree. For example, if ten Fans only are allowed to Interact with a Star for a planned Web cast interview, they can buy this right prior to or during the interview as interests build up. In either case Price can be determined by Pricing or by Auction or by a Formula based on future index such as Rating of same interview by independent agencies, or otherwise.

Pricing and or Auctioning or Grading are not necessarily integral to Exchanges. Many exchanges do not use them to associate offerors to offerees. For example in the financial world, a forum that simply lists Stocks for Sale is in a different category than a comprehensive Stock Exchange, which also posts prices, matches buyers and sellers, and acts as a clearing venue for what is bought and sold.

Briefing Some of Differences with Prior Art

The System and Method of this Application should not be identified with Prior Art of offering recorded content on-line. Some types of differences are mentioned.

First it introduces “new use” for some of prior art in various dimensions, offering on-line what has never been offered on the Internet, or offering what has been offered only on TV over the Internet, or introduction of Auctioning to what has never been auctioned before, such the right to talk to a Star.

Second introduction of what may have been applied by or Celebrities to others, Professionals, Persons or Entities. Also use of what previously used by ordinary businesses and persons to Celebrities. This is significant in that many uses are not so hot when used by ordinary people, but are commercially viable when celebrities are involved. On the other hand there is no reason not to use a system traditionally used by Celebrities, if it can benefit others too.

Third, this application extends use of Grading, Pricing, Auctioning and or other Selection methods to new domains, say Commodetizing & Auctioning Stars Time. Auctioning has so far been limited to sale of products delivered physically, not to sale of Content Delivered on Line. Auctions have so far been limited to products, and even contents were auctioned as products such as CDs, not live.

Fourth creating an Exchange for what has not had an Exchange before. Advantages and differences of an exchange verses ad hoc offering are numerous. Such differences are known to the skilled and need not be explained here. Imagine trying to sell shares of a private company as compared to one listed on a stock exchange, from buyers, sellers, societies or other points of view. For one, it takes much more advertising to bring as many buyers to a seller, without listing on an exchange, visited by potential customers.

An Exchange enables various Offerors to offer to various Offerees, without having to rely on any middleman or wholesaler. TimeEx creates various exchanges for what has never had an exchange before.

Fifth is various Permutations and Combinations of Steps that even though in isolation may or may not be novel, in combination is totally novel and unobvious. The System and Method of this Invention, incorporate not just on-line offering and selling of Recorded and Live Content, but add the crucial steps of Exchange and or a Bazaar or Media and Selecting methods such as auction for, revenue optimization and or selection of desired Users, Buyers, Fans, etc.

Offering “Shared Interactive Content”, especially when offered via an Exchange such as TimeEx, and or where limited shared time is allocated to some Fans or Offerees, using a selection process such as Pricing, and or non-monetary criteria and or Auctioning (a preferred way), is a totally new and useful commercial, educational and social system and method.

Prior art typically sells recorded content, such as a song, by one vendor, who has purchased from various singers, without letting those singers sell directly to listeners at the highest price they can get. This is a far cry from every singer being able to perform live for every listener who is willing to pay the price, and where the TimeEx merely acts as a forum or venue and provides all the technical support and templates to singers so that they don't have to reinvent the wheel each time.

Technical Viability

All of the technical and or electronic tools to make all components and perform all steps of the System and Method of this application exist and are being refined. Unavailable Software can all be developed using existing tools. There was no need to reiterate such fact in this Specification.

Technical and or Commercial Exclusivity

TimeEx can also “host” Stars Websites as well as providing a Directory of Links to Starsites or use any other method to link direct visitors to TimeEx Portal to their favorite Starsites. Hosting Starsites would make it easier to provide all the services we have mentioned, such as Pricing, Auctioning, Grading, Payments, Delivery, etc. If, as would be in most cases, TimeEx Operator wishes to prevent Fans to use TimeEx just to find Starsites, and then log onto them directly, to save paying TimeEx, there are many ways to prevent this happening.

One way is to host the Starsite, so that anyone has to come to TimeEx first before they can get to a Starsite, hence be charged along the way. Another way is to have long term fee arrangements with Stars, such that once a Starsite is noted via TimeEx by a Fan, the Star pays a commission every time the same Fan hits the Starsite directly.

Another is just charging Stars for any time their link is noted by a Fan on TimeEx, regardless of how many times it may be used directly in future.

Another is to pay or provide other incentive to Fans to link to Starsites via TimeEx. Then generate funds needed from extra Advertising and Star fees this can bring.

Another is to provide services needed by Stars, such as templates, auction tools, which can only be used via TimeEx, etc and or by Fans, such as news bulletins or tools to help Fans choose the hottest events, to make it more user friendly or sensible to use TimeEx, as compared to connecting to Starsites directly.

Another is membership that provides services to Fans and or Stars, for exclusivity and loyalty, making direct connections less viable or less attractive. There are other ways to force or entice Fans and Stars to use TimeEx, most or all of the time, but detailing them is not necessary as being known to the skilled.

Elaborations: mainly to support wording of present or future claims.

More Celebrity Features:

One difference between celebrities and professionals is that a Celebrity needs little advertising to be noticed, especially by his or her own Fans.

Another is that each Celebrity is unique. One can replace a doctor for another but Jay Lo is not replicable, to her fans with say J. Simpson.

Celebrities need not be solo. A Group or Panel of Celebrates can offer Content, be it Interactive, Live Passive, Archived, etc.

Content Delivery Generalization

Since such modes are evolving, no mention of a technology, say pod casting in this Application does not mean exclusion.

No Need to Impress

A major advantage of methods and means introduced here for Celebrities looking for publicity or revenue, is that they do not need to be selected by any Network, Producer, Distributor, Agent, especially when frowned upon by the industry, for her political views or to bring her fee down.

Authentication of Content or Qualification

One major advantage of a Market or Exchange is that service providers can be assigned to the task of authenticating Content sold or Qualifications or Data used to sell Service, Time, etc.

Rules of Using Shared Interactive Time

Such rules can be imposed before conducting any selection to choose who participates, or that chosen participants are led to choose, by voting, pricing, auctioning or otherwise, one of many standard ways or left to chosen participants.

Say if ten are chosen by auction to participate in an hour long Interactive session with a Celebrity, they are either told that say time is divided according to what they paid, and say those who paid more ask first. Alternatively they could be told to vote on equal time and first come first served or proportional time and moderator sequencing of who gets to ask first (all examples, not limiting). Also Auction each segment of time separately as an Exclusive Interactive Time.

Limited Edition Content

Even though each copy of a Content on the Internet costs little to produce, and hence no need to auction as a rare commodity, it may make sense to artificially rarify it, by making limited authorized copies and enforcing it technically or by law.

Markets and Exchanges

In this specification, a Market is a Forum, usually but not necessarily on line, where Vendors or Offerors introduce or list their merchandise, services, time to potential Buyers or Users. This aspect is similar to a Directory, if on line. An Exchange has the added feature that Buyers can also list their Requirements.

Both Markets and Exchanges, also have their in house Selection mechanism, such as Grading, Pricing or Auctioning, or at least enable or permit parties to do so off the Market or Exchange.

Both Markets and Exchanges either provide means of Delivery, or at least enable or permit parties to do so off the Market or Exchange.

For example, teaching time of a piano instructor and requirement of a student on listed an exchange can be matched by the exchange as its prime function, but then can be priced on or off the exchange by parities directly or on parties websites, and also can be delivered on line via the exchange or off the exchange by parties internet connections or even off line, in person.

Need less to say, exchanges and markets can be linked via internet or other means to create mega markets or mega exchanges, but such mega structures are just bigger markets and exchanges.

Multi Stage User Selection

Offering Content in one package may create User remorse when all of content is revealed, say User finding out that a Celebrity's dinner event with friends was no big deal. Yet revealing too much of the Content before receiving some consideration is unfair to Offeror. One method is to present an introduction and Select, by Grading, Pricing or even Auction, a more interested group of Users. Then repeat this procedure in one or more stages.

Time Defined Mercahndize

This application introduces merchandising different items all of which have fixed or flexible, exact or approximate start time and duration, as a major defining feature, such as but not limited to Celebrity's Interactive time, Professional's interactive time, Personal interactive time, Panel or Joint Interactive time, Group Interactive Participation time, Broadcast time, Airtime, Channel Time, Ad Slot, even though defined also as having a location on say the screen, but if each location on said screen is treated as a sub-screen, then each Ad Slot can be defined by start and duration.

Interactive, Live, Passive, Archived or Produced Content

Interactive content needs almost real time delivery, which is somewhat difficult. Live does not need to be real time, as long as the contents is does not become stale. When watching a soccer match, so long as the time lag between the event and viewing is short enough that viewer can control not to hear about the next move or result, it is substantially Live. For a TV sequel, an episode shown late is Live so long as it is after the prior episode and before the next and so long as the viewer can control not hearing about it, say by not talking to others who may have watched it. Some delay is very useful to help delivery and channel scaresity, and embarrassment reduction. Live Content is cherished by Fans, and utilized here.

Live can be Passive, as in a web cam productions, where what goes into Production is not the norm.

Archived Passive is the stored form of Live Passive Content.

Passive Content, Live or Archived is not only cheap to produce, but has unique appeal to Fans and utilized in this application.

Productions normally require research, scripting, audition, practice, grooming, staging, editing (beyond some embarrassment prevention for Live or Archived Content), montage, professional shooting, sound effects, movie or music studios, printing, etc. Productions are not only expensive, but often do not have the appeal of the other form of content. Note that many Live shows are not live and not believed by Fans or viewers as being Live.

A Novel Introduction Service

One variation of our Content Market and/or Exchange is that people auction the Right to be Interviewed or Met, on line or off line, by a potential suitor.

Conventionally, personal information is listed for suitors to choose. Problem is some receive too many suitors, and choosing the winner is inefficient, via a computer matching system which is yet to reach the required level of expertise, or just allow parties to contact each other.

This Application introduces bidding for a prospective spouse, boy or girlfriend or companion, so that the highest one or more bidders get to know more or meet al. the prospect. The prospect or her charity gets the money plus the comfort that the suitor is either more interested or richer than others or a combination. Pricing can also work instead of Auctions, but is not the preferred way. This method can also increase the Suitors by auctioning at a lower initial price or pricing lower, the right to be met.

Multi Stage Selecting can be used not to reveal too much, except to the more interested. First a brief of the Prospect, say a face picture is used to select a limited number of Suitors, by auction, pricing or otherwise. Then more info, say swim suit picture is revealed and so on.

A Novel Pricing Method

A pricing method that can generate interest in buyers or increase revenue for vendors of a scarce or plentiful merchandize is that a Vendor:
announces initial price applicable to first batch
pledges that each next batch will be costlier than its prior batch
optionally announces the number of mechanize for each batch or the time zone the price for a batch is valid or whichever comes first
announces the price or price increments optionally for each future batch

Said “options” give vendor plenty of leverage to design a static or dynamic strategy. Therefore it is better for each buyer to buy earlier than later, hence a rush to buy is created. Vendor's risk is that some merchandize may be not sold.

This method is more suitable to merchandize that for any reason can become stale, such as theater tickets, as otherwise unsold merchandize can be sold at a later time, when controls or memories fade.

Example, event tickets, even though unlimited for on line shows, may generate more revenue even if fewer buy, which few may get bragging rights to justify higher price, and it is cheaper to serve fewer buyers.

A control mechanism is desirable to assure earlier buyers that vendor's pledge that price can only go up is enforced. Also that vendor or its associates do not buy for themselves and if they do they pay a penalty to a third party not to give the vendor an advantage against some buyers.

Excluding PORN Business

This specification and claims excludes porn celebrities, porn operators and porn professionals. There are major differences between porn and other celebrities and professions, some are explored here.

Following arguments hold not relatively if not absolutely:
Looks are the main factor in porn. It is hard to imagine an ugly porn professional or celebrity, but easy to imagine an ugly surgeon better than a pretty one and plenty of successful ugly celebrities, especially non movie celebrities.
Even though old celebrities and professional maintain a fair degree of respect, most professionals increase their experience, most celebrities increase their stature, even after resignation, porn professionals and porn celebrities disappear.
Fans interest for peeping into celebrity's life is not to look at their bodies but for life stories. Even movie stars are not followed by fans for their looks, as photos, videos and films of such Celebes can be easily found showing same stars in much better light than they are in real life, to the extent that often seeing a celeb in real life spoils fantasies. The opposite is true for porn stars.
Fans are interested in looking into a Celebes say kitchen, not that of porn star's.
Porn Stars can be replaced by sexier ones, not so for Celebrities
There are cultural, religious, personal and health barriers preventing most to deal with porn profession or learn from it.

Porn Stars are a separate class and very different from Celebrities.

Porn Professionals are also very different from other Professionals.

Thus a business idea that works for porn stars or porn professional is not automatically perceived to apply to celebrities or professionals.

What is claimed is:

1- A method of utilizing the demand for information about a celebrity, for commercial or other benefits, comprising the steps of:
setting up a number of suitably equipped web cams to capture photos, videos, sounds and/or other information about said celebrity and/or things associated with her/him and/or things of interest to persons interested in said information referred to as fans,
feeding said captured information into the internet, live or delayed
enabling said fans to access said information in return for consideration
wherein information about more than one celebrity can be captured jointly, whereby said information, also referred to as content can be classified as;
interactive with said celebrity
live, but passive, even if with some acceptable delay
archived, a stored form of prior live passive or interactive content productions, or all other content
whereby numerous and substantial commercial and other benefits and advantages can be achieved by said celebrity, said fans and any operator of said method, as a result of utilizing a celebrity and the internet.

2- A method as in claim 1, wherein
a selection method or system is used to limit the number of participants in some or all said interactive sessions,
said selection method is a combination of grading, pricing, and auctioning
said selection method or system is preferably and on-line auction, whereas revenues or benefits from said celebrities interactive time are optimized.

3- A method of utilizing the demand for information about celebrities for commercial or other gain, comprising the steps of:
setting up an on line market
capturing digitized information, about celebrities referred to as content, by installing suitably equipped web cams in suitable locations
providing a directory of said celebrities accessible by those interested in said celebrities, referred to as fans
providing introductory data about each of said celebrities or each web cam to allow said fans to choose which web cam or which celebrity's page or site they wish to access
providing a selection system such as grading and or pricing and or auctioning to qualify fans who are allowed to access a web cam or celebrities page or site
providing a payment system to process any monies to be paid by fans and or a qualifying system to verify any non monetary compliance by fans
providing a content delivery system enabling fans who have paid or otherwise complied to access those web cams or pages or sites they are permitted to access
using any number of methods, such as advertising, subscription, user fees including charging or consideration for said content, to generate revenue or other benefits
said revenue or benefit methods to be imposed and also shared by said market and or said celebrities and or any associated service providers,
wherein said selection system, payment system, content delivery system, and revenue generating system can each be operated within said market and or by said celebrity and or by service providers,
wherein content about each celebrity can include interactive, live passive, archives of live passive contents, productions or other content,
whereas numerous commercial and other benefits are achieved as a result of said on line market for celebrities contents, in particular interactive and live contents.

4- A method of merchandising assets which have a fixed or flexible, exact or approximate, start time and or duration as defining features, by setting up an on line market and or exchange wherein;
offerors of said assets place offers for users to accept or bid for
users of said assets list their requirements or bids for offerors to offer prices or accept said bids
wherein a variety of matching systems identifies suitable, optimum or best matches, which matching systems can be;
auctioning of offered assets among interested users, as preferred version
intelligent matching software
offeror bidder communication
wherein said market and exchange enables trading of merchandize characterized by start and duration time or both, such as, but not limited to celebrities interactive time, professionals interactive time, personal meeting time, panel or joint interactive time, interactive group participation time, broadcast time, air time, channel time, advertising time, live content time,
wherein payment for and or delivery of sold assets is via or off said exchange,
wherein revenues and other benefits may be generated and shared by said exchange and said participants from advertising, subscription and otherwise,
whereas numerous and substantial monetary and other benefits can be achieved by creating said market and exchange for said types of time related assets.

5- Method of claim 4 wherein a prospect offers his or her time or the right to be interviewed or be met to a number of potential suitors, which number is reduced to a manageable size or increased to a desired size using pricing or auctioning.

6- Method of claim 4 wherein suitable viewers or audiences' time is purchased,
which time to be used for viewing or auditing some content or presentation and sold to those who wish their content or presentation is viewed or heard by said suitable viewers or audience.

7- A method of pricing a merchandize by a vendor to speed up sales comprising the steps of:
announcing a price for a first batch
pledging that the price of each future batch will be higher than its preceding batch
defining a price for each batch
defining each batch as a number of units of merchandize or as a time and duration for which said price is valid or as whichever expires first
manipulating said price and or batch definitions for some or all future batches by announcing them in advance or at strategic times or not announcing either or both
whereas potential buyers are assured that the earlier they buy the lower the price, but said manipulations also enable said vendor to reduce left over mechanize.

8- A method of improving utilization of limited content delivery media such as TV, radio and internet cable or wireless channels and or network time comprising the steps of;
selling content to be distributed prior to distribution to consumers and intermediaries, based on enough information required for purchasing
or surveying the potential buyers of said content as to potential of sale
obtaining buyers' demographics, geopgraphics, time of content delivery preferences, media of delivery preference, and other relevant information via said sale or survey
selling advertising time to be delivered along with delivery of said content, based on statistics of buyers of said contents
acquiring distribution rights for said content, if not already acquired, based on said relevant information plus information about revenue from sale of said content and advertising
commissioning production of said content, if not already produced
buying suitable delivery media, based on said relevant information and revenue statistics
informing said buyers or potential buyers of said content, by email, broadcast, internet, or whichever means said buyers are primed to look for, the time and media of delivery of the content of their interest
canceling those content and advertising, if allowed by terms of sale, for which either the content distribution rights or delivery media could not be viably secured
wherein said steps can be achieved via suitable markets and exchanges described or by setting up a suitable market,
wherein intelligent software can be employed to use said information for making decisions on best media of delivery of said content or other related decisions,
whereas many important decisions in the business of content production, acquisition, distribution and advertising are based on prior sales or surveys, rather than conventional guessing.
